(19) United States
(12) Patent Application Publication
(10) Pub. No.: US 2009/0003429 A1
(43) Pub. Date: Jan. 1, 2009

(54) Apparatus And Method For Processing A Bitstream

(75) Inventors: Yung-Chang Chang, Taipei City (TW); Chi-Cheng Ju, Hsinchu City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 11/769,133

(22) Filed: Jun. 27, 2007

(51) Int. Cl. H04B 1/66

(52) U.S. Cl. 375/240; 375/240.01; 375/E07.003

(57) ABSTRACT

Method and apparatus for processing a first bitstream are provided. The apparatus comprises an extraction unit and a generation unit. The extraction unit extracts an NAL unit from the first bitstream. The generation unit, coupled to the extraction unit, receives the NAL unit to generate a second bitstream according to the NAL unit. The second bitstream comprises a piece of information related to the NAL unit. The method comprises the steps of extracting an NAL unit from the first bitstream and generating a second bitstream comprising a piece of information related to the NAL unit.

### CROSS-REFERENCES TO RELATED APPLICATIONS

Not applicable.

### BACKGROUND OF THE INVENTION

1. Field of the Invention

The present invention relates to a system, an apparatus, and a method for processing a bitstream. More particularly, the present invention relates to an apparatus and a method for processing a first bitstream into a second bitstream which comprises a predetermined code for each NAL unit.

2. Descriptions of the Related Art

H.264/Advanced Video Coding (H.264/AVC) is the latest video coding standard, which aims to enhance compression performance and provides network-friendly video coding/transmission. The goal of network-friendly video coding/transmission is achieved through Network Abstraction Layer (NAL) units.

An NAL unit comprises a header and a payload. The header of an NAL unit provides information related to the NAL unit. As to the payload of an NAL unit, the content of the NAL unit depends on its type. To be more specific, if the NAL unit is a Video Coding Layer (VCL) NAL unit, its payload contains video data framed by the VCL. If the NAL unit is a non-VCL NAL unit, its payload comprises parameter sets and supplemental enhancement information. The definition of the NAL unit specifies a generic format for use in both bitstream-oriented and packet-oriented transport systems. That is, both bitstream-oriented systems, such as H.320 and MPEG-2/H.222.0, and packet-oriented transport systems, such as Internet protocol/RTP systems, are able to process NAL units.

Bitstream-oriented systems require NAL units to be delivered as an ordered stream of bytes. Within the ordered stream, boundaries of the NAL units are identifiable because each NAL unit is prefixed by a specific pattern of three bytes called a start code (i.e. a predetermined code), which marks the beginning of the corresponding NAL unit.

For packet-oriented systems, the coded data is carried in packets that are framed by the system transport protocol. However, identification of the boundaries of NAL units is not established by use of start codes (i.e. predetermined codes). Instead, the byte size of each NAL unit needs to be stored so that a decoder can identify the size of each NAL unit. A byte counter is then required to calculate where the beginning of an NAL unit is according to the stored byte sizes. One drawback of the packet-oriented system is that having a byte counter increases hardware complexity and production cost. Additionally, errors that occur during transmission cannot be well handled. If an error arises, it is difficult for the decoder to skip the error and identify a next slice for display quickly since a relatively substantial amount of time is needed to calculate and identify the location of the next NAL unit.

According to the aforementioned details, a solution with improved performance that efficiently resolves errors and reduces hardware complexity for packet-oriented systems is in high demand.

### SUMMARY OF THE INVENTION

An object of this invention is to provide a method for processing a first bitstream. The method comprises the steps of extracting an NAL unit from the first bitstream and generating a second bitstream according to the NAL unit, wherein the second bitstream comprises a piece of information related to the NAL unit.

Another object of this invention is to provide an apparatus for processing a first bitstream. The apparatus comprises an extraction unit and a generation unit. The extraction unit is configured to extract an NAL unit from the first bitstream. The generation unit, coupled to the extract unit, is configured to receive the NAL unit to generate a second bitstream. The second bitstream comprises a piece of information related to the NAL unit.

Still, another object of this invention is to provide a method for processing a first bitstream. The method comprises the steps of extracting an NAL unit from the first bitstream and adding a marker to the NAL unit to generate a second bitstream.

The present invention extracts an NAL unit from a first bitstream and adds a predetermined code as a header of the NAL unit to form a second bitstream. With the predetermined code, a counter is not required to count byte numbers when decoding the second bitstream. In addition, storing the byte size of an NAL unit is also unnecessary. When a fast forward function or a fast backward function of playback systems is executed or a transmission error is detected, it is easy to find the next NAL unit by locating the predetermined codes in the second bitstream. Consequently, the present invention reduces the hardware complexity and improves the decoding performance and efficiency.

The detailed technology and preferred embodiments implemented for the subject invention are described in the following paragraphs accompanying the appended figures for people skilled in this field to well appreciate the features of the claimed invention.

### BRIEF DESCRIPTION OF THE DRAWINGS

FIG. 1 illustrates a first embodiment of the present invention;

FIG. 2A illustrates a first bitstream of the present invention;

FIG. 2B illustrates a second bitstream of the present invention;

FIG. 3 illustrates a second embodiment of the present invention; and

FIG. 4 illustrates a third embodiment of the present invention.

### DESCRIPTION OF THE PREFERRED EMBODIMENT

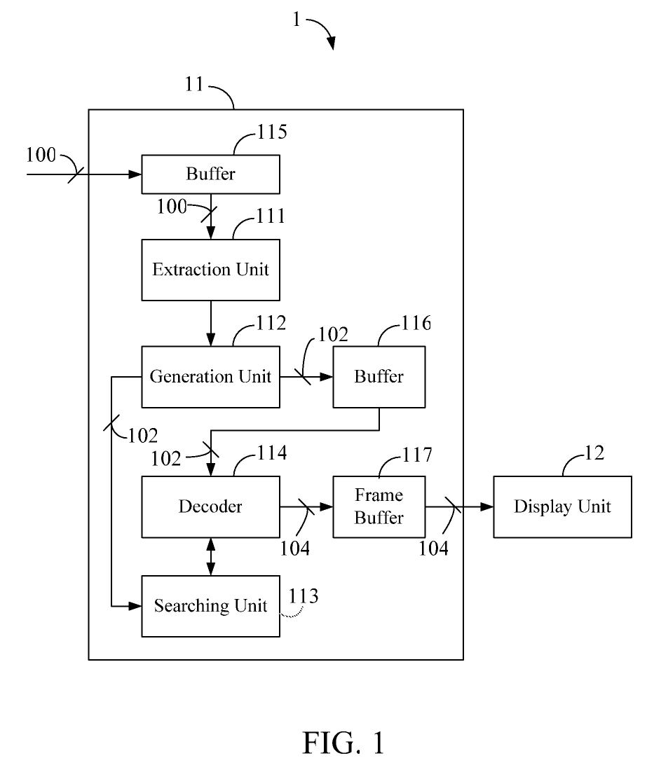

FIG. 1 illustrates a first embodiment of the present invention, which is a multimedia playback system 1. The multimedia playback system 1 comprises a processor 11 and a display unit 12. The processor 11 comprises an extraction unit 111, a generation unit 112, a searching unit 113, a decoder 114, two buffers 115 and 116, and a frame buffer 117.

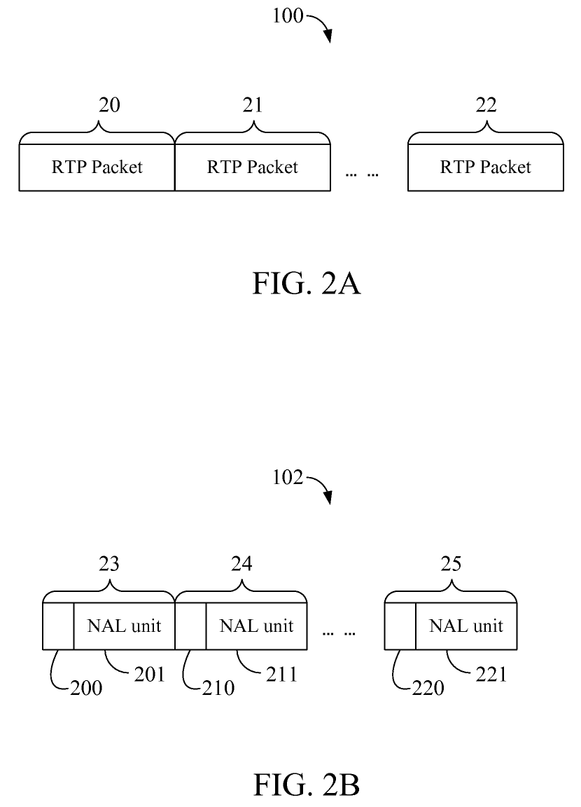

The buffer 115 stores a first bitstream 100 comprising at least one NAL unit transmitted by a transmitter (not shown). The first bitstream 100 is formed for packet-oriented systems. In other words, the NAL units in the first bitstream 100 are not separated by predetermined codes. The first bitstream 100 comprises a plurality of RTP packets 20, 21, and 22 as illustrated in FIG. 2A. Each of the RTP packets 20, 21, and 22 carries one NAL unit. The extraction unit 111 is configured to retrieve the first bitstream 100 from the buffer 115 and to extract the NAL units from the first bitstream 100. That is, the extraction unit 111 extracts the NAL units from the RTP packets 20, 21, and 22. It is noted that the buffer 115 is optional. For those embodiments without the buffer 115, the extraction unit 111 retrieves the first bitstream 100 directly.

The extraction unit 111 further transmits the NAL units to the generation unit 112, which is configured to generate a second bitstream 102 according to the extracted NAL units. The second bitstream 102 is generated as shown in FIG. 2B, wherein the NAL unit 201 is extracted from the RTP packet 20, the NAL unit 211 is extracted from the RTP packet 21, and the NAL unit 221 is extracted from the RTP packet 22. Furthermore, the generation unit 112 generates pieces of information related to the NAL units 201, 211, and 221 in the second bitstream 102 functioning as markers for identifying the NAL units 201, 211, and 221. In this embodiment, these pieces of information are predetermined codes 200, 210, and 220 for identifying the beginnings of the NAL units 201, 211, and 221. More particularly, the generation unit 112 prefixes the predetermined code 200 to the NAL unit 201, the predetermined code 210 to the NAL unit 211, and the predetermined code 220 to the NAL unit 221. The predetermined codes 200, 210, and 220 and the NAL units 201, 211, and 221 together form the second bitstream 102. This second bitstream 102, a byte stream, is then stored in the buffer 116. It is noted that the buffer 116 is also optional. For those embodiments without the buffer 116, the generation unit 112 transmits the second bitstream 102 to the decoder 114 directly.

The decoder 114, such as an H.264 compatible decoder, is configured to retrieve the second bitstream 102 from the buffer 116 and decode the NAL units 201, 211, and 221 in the second bitstream 102. For those embodiments without the buffer 116, the decoder 114 retrieves the second bitstream 102 from the generation unit 112 directly. After the decoder 114 decodes the NAL units 201, 211, and 221 into video frames 104, the video frames 104 are temporarily stored in the frame buffer 117, wherein each video frame comprises at least one slice. The display unit 12 is configured to retrieve the video frames 104 from the frame buffer 117 and display the slices in the video frames 104.

If a transmission error occurs before the buffer 115 receives it, the decoder 114 would decode the second bitstream 102 erroneously and the display unit 12 would not display correctly. In such a circumstance, the searching unit 113 searches for a next NAL unit by locating the predetermined codes 200, 210, and 220. Since the predetermined codes 200, 210, and 220 are specific patterns, such as 0x00000001, the searching unit 113 simply searches for the specific pattern without counting the byte numbers. Similarly, when the fast forward or fast backward function of the multimedia playback system 1 is executed, the searching unit 113 searches for an NAL unit by locating the predetermined codes. Thus, with the information of the NAL unit, a desired frame for the fast forward or fast backward function is obtained. With the predetermined codes 200, 210, and 220, the NAL unit can be located easily and quickly when an error occurs or fast forward or fast backward function is executed. Thus, the decoder 114 can perform error concealment more easily.

It is worth to mention that the multimedia playback system 1 can also be a television.

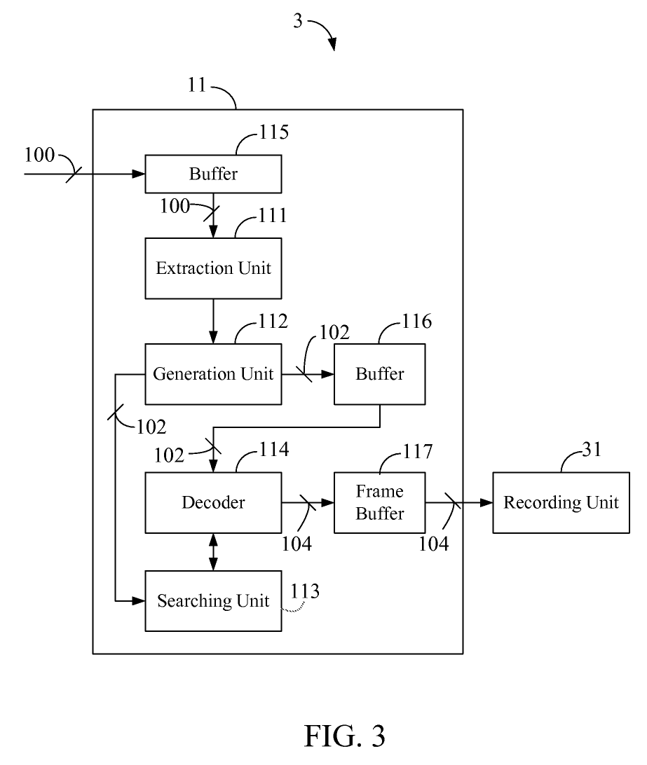

A second embodiment of the present invention is a digital video recorder 3 as shown in FIG. 3. In contrast to the multimedia playback system 1, the digital video recorder 3 comprises a recording unit 31 instead of the display unit 12. The recording unit 31 records the video frames 104. The recording unit 31 records the NAL units 201, 211, and 221 according to the second bitstream 102. When an error in the first bitstream 100 occurs, a next NAL unit can be found easily and quickly by searching the predetermined codes 200, 210, and 220. Thus, the recording unit 31 is able to record the error-concealed picture directly.

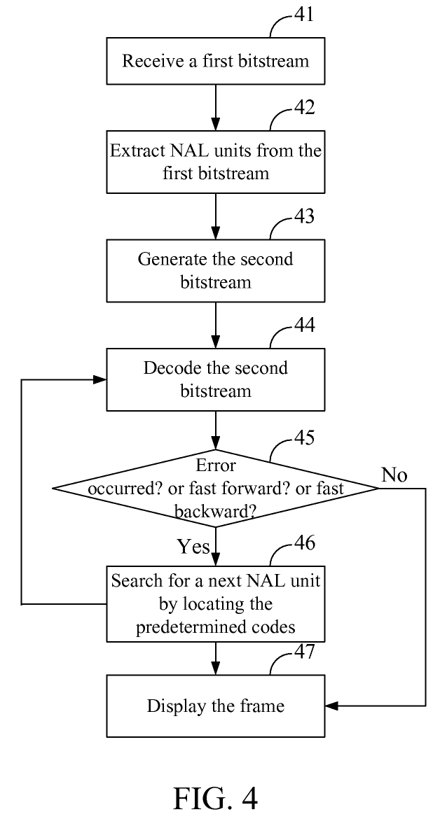

A third embodiment of the present invention is a method for processing a first bitstream adapted for a system such as the multimedia playback system 1. FIG. 4 illustrates the flowchart of the method. First, the method executes step 41 to receive the first bitstream comprising at least one NAL unit. Then, step 42 is executed to extract the NAL units from the first bitstream. Step 43 is then executed to generate the second bitstream according to the NAL unit, wherein the second stream comprises the NAL units and a plurality of predetermined codes for the NAL units. The predetermined codes function as markers for identifying the NAL units. The method proceeds to step 44 to decode the second bitstream. In step 45, it is then checked whether an error has occurred or the fast forward or fast backward function of the system is executed. If none of the described conditions happens, a plurality of slices in decoded frames is displayed in step 47. Conversely, under any of the described conditions, the method executes step 46 to search for a next NAL unit corresponding to a next slice for display by searching for the predetermined codes in the second bitstream. Proceeding to step 47, the next frame is displayed or the error concealment is performed.

In addition to the steps shown in FIG. 4, the third embodiment is able to execute all of the operations or functions detailed in the first embodiment. Those skilled in the art are able to realize the functions of the third embodiment based on the described descriptions of the first embodiment. Therefore, the descriptions for these operations and functions are redundant and not repeated herein.

The present invention extracts NAL units from a first bitstream and adds predetermined codes for identifying the NAL units to form a second bitstream. For example, the predetermined code is added to the beginning of each NAL unit as a header thereof. Hence, a counter is unnecessary to be implanted to count byte numbers when decoding the second bitstream including the predetermined codes. In addition, storing the byte size of an NAL unit is also unnecessary. When an error is detected, it is easy to find a next NAL unit corresponding to a next slice for display by locating the predetermined codes in the second bitstream. Consequently, the present invention reduces the hardware complexity and improves the decoding performance.

The above disclosure is related to the detailed technical contents and inventive features thereof. Those skilled in this field may proceed with a variety of modifications and replacements based on the disclosures and suggestions of the invention as described without departing from the characteristics thereof. Although such modifications and replacements are not fully disclosed in the above descriptions, they have substantially been covered in the following claims as appended.

What is claimed is:

1. A method for processing a first bitstream, comprising the steps of:
extracting a Network Abstraction Layer (NAL) unit from the first bitstream; and
generating a second bitstream according to the NAL unit;
wherein the second bitstream comprises a piece of information related to the NAL unit.

2. The method of claim 1, wherein the first bitstream comprises a Real-time Transport Protocol (RTP) packet.

3. The method of claim 1, wherein a format of the second bitstream is a byte stream format.

4. The method of claim 1, wherein the piece of information is a predetermined code for identifying the NAL unit.

5. The method of claim 4, wherein the predetermined code is added to a beginning of the NAL unit.

6. The method of claim 4, further comprising a step of searching for the NAL unit in the second bitstream by locating the predetermined code.

7. The method of claim 1, further comprising a step of decoding the NAL unit.

8. The method of claim 7, wherein the decoding step is H.264 compatible.

9. An apparatus for processing a first bitstream, comprising:
an extraction unit for extracting an NAL unit from the first bitstream; and
a generation unit coupled to the extraction unit for receiving the NAL unit therefrom to generate a second bitstream;
wherein the second bitstream comprises a piece of information related to the NAL unit.

10. The apparatus of claim 9, wherein the first bitstream comprises an RTP packet.

11. The apparatus of claim 9, wherein the second bitstream has a byte stream format.

12. The apparatus of claim 9, wherein the piece of information is a predetermined code for identifying the NAL unit.

13. The apparatus of claim 12, wherein the predetermined code is added to a beginning of the NAL unit.

14. The apparatus of claim 12, further comprising a searching unit coupled to the generation unit for searching for the NAL unit in the second bitstream by locating the predetermined code.

15. The apparatus of claim 9, further comprising a decoder coupled to the generation unit for receiving and decoding the second bitstream.

16. The apparatus of claim 15, wherein the decoder is H.264 compatible.

17. The apparatus of claim 15, further comprising a searching unit coupled to the generation unit and decoder for searching for the NAL unit in the second bitstream by locating the predetermined code and transmit the NAL unit to the decoder, allowing the decoder to decode the next NAL unit.

18. A method for processing a first bitstream, comprising:
extracting an NAL unit from the first bitstream bitstream; and
adding a marker to the NAL unit to generate a second bitstream.

19. The method of claim 18, further comprising locating the NAL unit in the second bitstream with the marker.

20. The method of claim 18, wherein the marker is a predetermined code for identifying the NAL unit.

21. The method of claim 20, wherein the predetermined code is added to a beginning of the NAL unit.

22. The method of claim 18, wherein the first bitstream is a packet-based bitstream.

23. The method of claim 18, wherein the second bitstream has a byte stream format.
